(19) United States
(12) Patent Application Publication
(10) Pub. No.: US 2016/0371687 A1
(43) Pub. Date: Dec. 22, 2016

(54) ELECTRONIC PAYMENT SYSTEM WITH TRANSACTION DISCOUNT BASED UPON PURCHASED GOOD OR SERVICE

(71) Applicant: Knotis Inc., Seattle, WA (US)

(72) Inventors: Josie M. Imlay, Seattle, WA (US); McLean R. Reiter, Seattle, WA (US)

(73) Assignee: Knotis Inc., Seattle, WA (US)

(21) Appl. No.: 15/187,712

(22) Filed: Jun. 20, 2016

Related U.S. Application Data
(60) Provisional application No. 62/182,318, filed on Jun. 19, 2015.

(51) Int. Cl. G06Q 20/40; G06Q 30/02

(52) U.S. Cl. CPC G06Q 20/401; G06Q 30/0223

(57) ABSTRACT

An electronic payment system that allows a payer to obtain an economic benefit in a payment transaction for a specific good or service. The system can provide either a direct financial discount in the currency or value units of the transaction, such as with a coupon discount for a specific good or service purchased, or the system can have a secondary benefit conferred on the transaction that can later accrue to a payer in a different transaction, such as a voucher or credit or other value unit. The use of the electronic payment system is of such advantage to the payer that specific actions can be requested of the payer prior to use of the system, such as gathering market data or answering a survey. The system can also provide a demand market for coupons, discounts, and utility units of value to a user by providing interested entities with item data that the user is contemplating purchasing.

### CROSS-REFERENCE TO RELATED APPLICATION

This application claims the benefit of U.S. Provisional Patent Application No. 62/182,318, filed on Jun. 19, 2015, the entirety of which is hereby incorporated herein by this reference.

### BACKGROUND OF THE INVENTION

1. Field of the Invention

The present invention generally relates to systems that effect electronic purchase transactions. More specifically, the present invention relates to a system that allows an electronic purchase transaction to occur with a transaction discount based upon the good or service purchased, and the discount can occur in the same economic unit as the purchase transaction, such as money, or can occur through the provision of a secondary economic unit, such as a coupon or other voucher or credit of economic value.

2. Background of the Invention

Electronic point-of-sale and online payment systems have existed for many years. The widespread use of “credit cards” have allowed people to purchase goods by physically using the credit card with a machine at the point of sale and swiping a magnetic strip through a credit card reader, having a chip in the card relay data to a reader, or near-field electronic data allows the card to be placed in the proximity of a reader and the card data is wirelessly gathered and used for the payment.

The credit card numbers themselves are also used for electronic payments across the internet and over the phone where physical contact with the credit card is unnecessary to complete the payment transaction. The payment is effected through the computer network of the credit card company that verifies the card, the funds present, and often performs the financial transaction and delivers the funds to the merchants account for the payment transaction and can deduct money from the account of the payer, such as would occur with the use of a debit card connected to a back account. The credit card company will typically charge for the use of their electronic payment system with a fee to the merchant as a percentage of the financial transaction.

There are also other electronic methods of payment that are not directly linked to a specific credit card or electronic transaction payment system. There are individual electronic payment accounts that are accessible from the interne and that allow persons to fund accounts through a variety of manners, including money transfer from bank accounts, credit cards, and payment received from another that is credited in the electronic payment account. The electronic payment account can also be held in a “mobile wallet” on a handheld mobile device that can then communicate with point of sale devices through near-filed communication protocols, such as Bluetooth, and can effect payment from the mobile wallet.

One problem that arises in the field of electronic payments is that, while the merchant typically bears the cost for the transaction using the electronic payment system, there is little advantage to the customer beyond the ease of use of the credit card or near filed electronic wallet removing the need to pay with physical money. There are often multiple methods for the customer to pay at checkout, through either cash or different forms of electronic payment. The payer may be able to get some reward points or other financial incentive for paying with a credit card that has an incentive program tied to purchases. But, these electronic payment systems do not give any specific advantage to the payer in using the payment system in a specific transaction, such as a specific purchase of a good or service, and do not typically give the consumer a significant motivation to take further action in making the purchase transaction, such as providing marketing information or taking other actions such that the payer can utilize the electronic payment system. In the worst case scenario, the merchant can give a negative incentive to the customer for using an electronic payment system, such as charging one price for the good or service when it is paid for in cash, but a different and higher price for use of the electronic transaction system. Here, the merchant is basically passing along the cost of using the electronic transaction to the customer.

### SUMMARY OF THE INVENTION

Briefly described, the present invention is directed to an electronic payment system that allows a payer, such as a consumer, to obtain an economic benefit in a payment transaction for a specific good or service. Other than ease of use and potential credit card company incentives, a consumer does not have a significant incentive to use one payment form over another, and depending on the merchant, may even be financially motivated to make the payment in cash to avoid the cost of using an electronic payment system. The present system addresses this by providing a potentially significant financial incentive to the consumer to use the electronic payment system and enter a purchase transaction.

In one embodiment, the system can provide either a direct financial discount in the currency of the transaction (a first transactional value unit), such as a coupon discount for a specific good or service purchased, or the system can have a secondary benefit conferred on the transaction that can later accrue to the payer in a different transaction, such as a voucher or credit or another second transactional value unit. Through this benefit, the use of the electronic payment system is of such advantage to the payer that specific actions can be requested of the payer to gain at least second transactional value units prior to use of the system, such as gathering market data, answering a survey, and the like.

In one embodiment, the user and potential payer in the electronic payment system is known, such as through an account already created by the user. The account can be resident on an application on a mobile device. The system has access to a database indicative of potential discounts of a good or service, and then when a user wants to purchase a good or service, the system requires that the user input data of what is desired to be purchased, such as an item on the shelf of a store. The user will input the data, such as photo of the item(s) or otherwise input item data of the potential purchase, and the system will let the user know if any of the items input are subject to a potential discount, such as a coupon or other transaction value unit, or can push out the item data to see if any particular manufacturer or sales entity in the sales chain wishes to provide a discount or some unit of value to the user for purchasing the item. In order for the user to then get the benefit of any potential discount, the user will have to use the electronic payment system to purchase the good or service. The potential discount can be to the price of the purchase of the present transaction, such as use of the coupon to lower the cost, or the discount can be some other benefit that has value to the user, such as a credit or voucher that can be used in another transaction or have other value to the user.

In another embodiment, the system and method can create a demand market for a coupon or a discount for goods or services that the user intends to buy. Once the item data is captured by the user and obtained by the data center or other system device, the item data can be pushed out to other third party entities, such as the manufacturers of an item or the retailer of the item, and request the one or more entities to indicate if they wish to add a coupon, rebate, discount or other utility unit of value to the user in order to have the user purchase the item. The later provision of a discount can be virtually instantaneous to the user after the item data is captured and sent, or be sent some time after the item data capture, such as by a push notification to the application resident at the mobile device that there is a coupon or other unit of value to purchase the item inquired about. The later provision of the coupon or other unit of value can even be applied at checkout itself and the user will learn of the discount applied at the time of payment.

The system can be embodied in any electronic payment system, such as an application on a mobile device, an electronic wallet or account accessible on the internet, or through a credit card payment system. The potential discount for the user can be significant enough to motivate the user to perform other actions in order to determine if discounts are available, such as having the user take photographs of all items on shelf, either of the items desired to be purchased or of other items, input other information on what the user wants to buy in addition to the sought items, or even perform an on-the-spot survey. The system can therefore acquire significant marketing data that is useful to sellers of goods or services, and to the retailer or store owner regarding the users and purchase transactions.

It can thus be seen that the present invention can embrace a series of servers or other computers that are accessible via a computer network, and that can communicate with other fixed and mobile computer devices to effect an electronic payment transaction with the potential discount. The invention can also embrace an application or other program at the electronic device of the user, which can be either a fixed or mobile computer device, that obtains information from the user to relay to the computer system across the network and can effect the payment transaction in the underlying currency or transaction value unit, such as through near field communication with a payment reader or through the swiping of a specific credit card linked to the payment system. The invention therefore also embraces the methodologies by which the present electronic payment system can be performed, including, but not limited to, the data capture, user point-of-sale motivation, discounting of payment transactions, and primary and secondary systems of discounts used to incentivize the user to utilize the system to make an electronic payment.

### BRIEF DESCRIPTION OF THE DRAWINGS

FIG. 1 is a representative diagram of an electronic payment system that allows mobile devices to determine if goods and services on sale at a specific retail location are discounted.

FIG. 2 is a representative diagram of a user of a mobile device taking a picture of items on a retail shelf so that the system can determine if any of the items have a discount available.

FIG. 3 is a representative diagram of a user checking out with an electronic payment system at a cash register of a retail establishment such that the discount for the item is applied in the payment transaction.

FIG. 4 is a flowchart of one embodiment of a server receiving a request from a user to look up on or more items to see if any of the items are discounted.

FIG. 5 is a flowchart of one embodiment of a payment system receiving a payment request and applying any discount for the item that was looked up by the user.

FIG. 6 is a flowchart of one embodiment of a process at a mobile device to take a picture of one or more items desired to be purchased, transmit the information to the server, and inform the user on received information regarding potential discounts.

### DETAILED DESCRIPTION

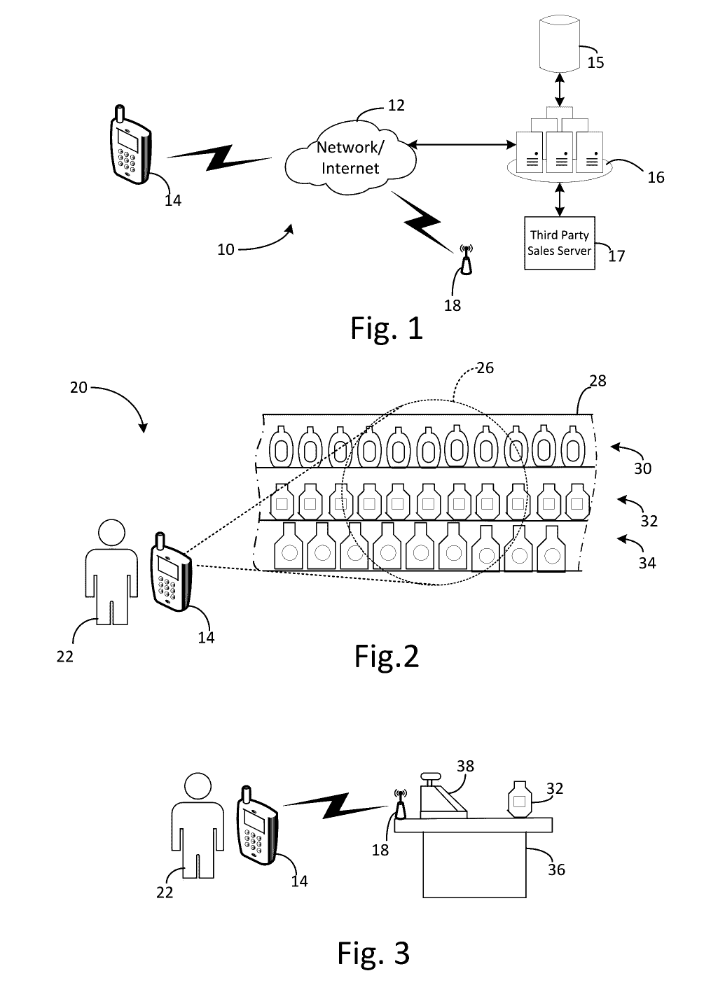

In overview, the present invention is embodied in FIG. 1 which is a representative diagram of an electronic payment system 10 that allows mobile devices 14 to determine if goods and services on sale at a specific retail location are discounted. The goods or services are purchased in a first transactional value unit, such as currency, either in paper money form or an electronic currency transaction. The system uses wireless network 12, such as the Internet, to communicate with a data center 16 that can include one or more servers and networked computer devices as is known in the art. The data center 16, as embodied here, includes a database 15 that stores of potential purchase transactions, such as specific goods or services that can be purchased, or links to other data sources for specific purchase, e.g., a manufacturer's website. The database also contains second transactional value units, such as coupons, vouchers, etc., that are potentially applicable to potential purchase transactions, where the second transactional value units have a different value than a first transactional value unit that can be used within a purchase transaction. For example, a data item could exist for the purchase of a bottle of ketchup, that is $3 in the first transactional value unit, and also has a 50¢ coupon applicable as a second transactional value unit if the purchase transaction of the ketchup is done by the user 22.

The data center 16 can also include connectivity to a third party server 17, such as a manufacturer, distributer or retailer server that the data center 16 can connect to when a purchase transaction is request by a user 22 of the system 10 as further described herein. For example, upon a user 22 requesting to purchase a bottle of ketchup from a group of ketchup bottles, as shown in FIG. 2, the data center 16 can contact the individual manufacturers of the ketchup at their servers 17 to inquire if they wish to add second transactional value units, such as coupons, to the potential purchase transaction to entice the user to buy the product. In such manner, an auction or other competitive event can be held by entities in an interest in the real time competition to entice the user 22 to purchase a specific one of the ketchups.

Other wireless points of sale 18 are also potentially used in the system 10, as is further shown in FIG. 2. The system 10 there has access to data indicative of potential discounts of a good or service, which is stored at data center 16, such as coupons, vouchers, special sales applied at the point of sale, and the like, within the database 15 or readily available from third party servers 17, or a combination thereof.

FIG. 2 is a representative diagram of a user 22 of a mobile device 14, which includes a camera (not shown) taking a picture 26 of items 30,32,34 on a retail shelf 28 through a lens view 24 of the mobile device 14 so that the system 10 can determine if any of the items in the picture 26 have a discount available, such as a coupon, voucher or other financial benefit available to the user 22 to purchase one or more of the items 30,32,34. The coupon can be a general manufacturers coupon available to everyone, a specific coupon only available for users of the system 10 for specific items, a generic coupon for one type of item, e.g., Ketchup, diapers, etc., or could be a cash discount for the transaction, e.g., tell the user there is a coupon in the system for $5 off of a $30 or more purchase. Through the electronic payment system 10, the payer, such as a consumer or user 22 here, can obtain an economic benefit in a payment transaction in a first transactional value unit, e.g., a currency transaction, via paper or electronic, for a specific good or service. Here, the user 22 is informed that there is coupon available for the items 32. The user 22 will then select the item 32 assuming that they want the discount and then head to checkout to pay using the electronic payment system 10, which is shown at the retail counter 36 in FIG. 3.

In one embodiment, through the item data capture, such as picture 26, the system 10 can create a demand market for a coupon or a discount for goods or services that the user intends to buy, such as items 30,32,34. Once the item data is captured by the user 22 and obtained by the data center 16 or other system device, the item data can be pushed out to other entities, such as the manufacturers of an item or the retailer of the item, such as through a communication to a third party server 17 (FIG. 1), and request the one or more entities to indicate if they wish to add a coupon, rebate, discount or other utility unit of value to the user in order to have the user purchase the item. For example, the retail store may be interested in moving specific inventory approaching its shelf life and will apply a store coupon to entice the user 22 to buy the item. And a manufacturer of the item may wish to increase the sale potential at that particular time for or try to dispose of old inventory as well. The item data for all items being scanned can also be given to all parties who want to potentially add a coupon or unit of a value to the user 22 in order to cause the user 22 to purchase a specific item, such as item 32. In such manner, the system 10 can create a reverse discount auction between competing entities, letting them bid against each other and then send the best discount, coupon or second transactional value unit to the user 22 to purchase the item.

When so embodied, the later provision of a discount can be virtually instantaneous to the user 22 after the item data is captured and sent, e.g., the picture 26 is taken and sent, or the coupon or discount data can be sent some time after the item data capture, such as by a push notification to the application resident at the mobile device 14 that there is a coupon or other unit of value to purchase the item inquired about at some time after item data capture. This delay allows for the provision for a demand market for coupons, rebates, units of value, etc., as the competing entities have time to engage in a reverse auction. The later provision of the coupon or other unit of value can even be applied at checkout itself and the user 22 will learn of the discount applied at the time of payment, such as shown in FIG. 3.

In one embodiment, the system 10 can provide either a direct financial discount to the user 22 in the currency of the transaction, or the first transactional value unit, such as a money-value coupon discount for a specific good or service purchased, or the system 10 can have a secondary benefit conferred on the transaction in a second transactional value unit that can later accrue to the user 22 in a different transaction, such as a voucher or credit that may or may not have any money value. Though this benefit, the use of the electronic payment system is of such advantage to the payer that specific actions can be requested of the payer prior to use of the system, such as gathering market data, answering a survey, and the like. The user 22 will have an application on the mobile device 14 and an account kept at data center 16 such that the user 22 can utilize credits or other economic units can be inserted from other purchases or transactions, or use information from the present transaction such that a discount may not be applied in the current transaction, but would be applied at a later date to the benefit of the user 22.

In one embodiment, in order for the user to then get the benefit of any potential discount, the user will have to use the electronic payment system to purchase the good or service, as shown in FIG. 3. FIG. 3 is a representative diagram of a user 22 at a checkout 36 with an electronic payment system 10 through a wireless terminal 18 at a cash register 38 of a retail establishment such that the discount for the item 32 is applied in the payment transaction. The mobile device 14 can have a mobile wallet or other unique application or identifier to allow a payment of money to the store, or some other transactional value unit or economic utility, and the payment can be reduced by discount to the user 22 to partial or full discount of the item 32, i.e., to the user 22, even to the point where it will cost the user 22 nothing. If the system 10 was embodied as performing a delayed solicitation of coupons or units of value, such as through a reverse auction, the user 22 can learn of the applied discount(s) at the time that the payment is made. The back-end of the financial transaction, e.g., applying first transactional value units (e.g., money) and any second transactional value units (e.g., coupons, purchase points, etc.), will be transparent to the user, and can be effected at data center 16 or another computer system, such as third party server 17, in communication with data center 16 that provides for electronic payments.

Accordingly, the system 10 can be embodied in any electronic payment system, such as an application on a mobile device 14, an electronic wallet or account accessible on the interne 12, or through a credit card payment system, with near-field capability or not. Furthermore, the potential discount for the user 22 can be significant enough to motivate the user to perform other actions in order to determine if discounts are available at the retail store, such as having the user take photographs of all items on shelf, either of the items desired to be purchased or of other items, input other information on what the user 22 wants to buy in addition to the sought items, or even perform an on-the-spot survey. The system 10 can therefore acquire significant marketing data that is useful to the seller of the good or service, and to the retailer or store owner regarding the users and purchase transactions.

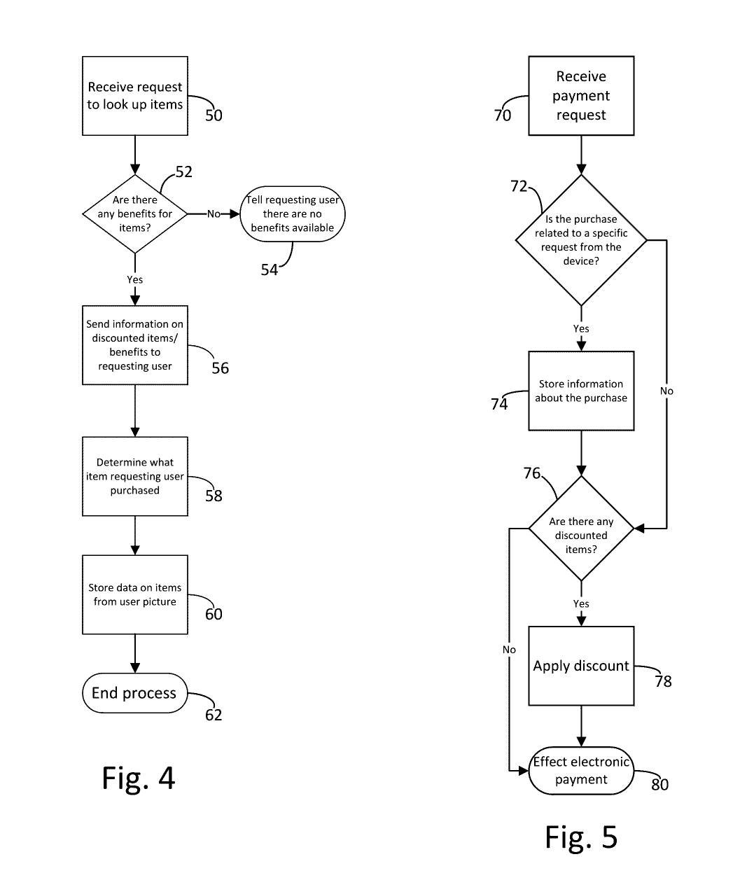

FIG. 4 is a flowchart of one embodiment of a server, such as at data center 16, receiving a request from a user 22, through an application on a mobile device 14, to look up on or more items to see if any of the items are discounted. The process starts first with system 10 receiving a request to look up on or more items, such as items 30,32,34 captured in picture 26 in FIG. 1, as shown at step 50. Then a determination is made as to whether there are any coupons for the items 30, 32, 34 as shown at decision 52. Decision 52 can be the identification of other economic benefits to the user 22 than coupons, such as vouchers, credits, bonus points, rain checks, and other benefits that might not be able to be used in a transaction with the current items as contemplated, e.g., potentially a second transactional value unit that is not identical to the first transactional value unit used in the purchase transaction asked by the user 22. If there is not a coupon (or other benefit or opportunity of value to the user) available for the items 30,32,34, as shown at decision 52, then a notice is sent to the requesting user 22 to tell them no benefits are available, as shown at termination 54.

If the system 10 is so embodied, if no coupons are available at decision 52, the captured item data can be sent out to other interested entities, as described above, such as a communication to a third party server 17, to see if any entity wishes to add a coupon or other unit of value to the item in the purchase transaction, or potentially engage in a reverse auction among the entities to obtain the best discount for the items 30, 32, 34. Thus, in such embodiment, decision 52 would enter an appropriate wait state to allow adequate time for the response from the entities regarding a coupon or unit of value given to the user 22 for purchase of a particular item. If no coupons or units of value are provided after the wait state, then the then a notice is sent to the requesting user 22 to tell them no benefits are available, as shown at termination 54.

Otherwise, if there is a benefit available for the items 30,32,34 at decision 52, then the information of the discounted item(s) or benefit, such as discounted item 32 in FIG. 2, is sent to the requesting user as shown at step 56. At this step, other questions can be asked of the user 22 or other tasks given, such as to take pictures of other times, answer surveys, or give information on what specific product they would like to purchase at what discount. After step 56, a determination is made as to whether the user 22 actually purchased any of the items 30,32,34 for which as request for information was sent, as show at step 58. The verification can be accomplished by the use of the electronic payment system as shown in FIG. 3, and the process of FIG. 5. Then, the data for the items from the picture is stored as shown at step 60, and the process terminates as shown at termination 62. The stored data can be any data of relevance to the event, such as the items shown, their relative prices, the volume of items, location, temperature data, sound, or any data capturable by the sensors of the mobile device 14. The corresponding data to the sale can then be utilized for marketing or retail purposes, or sent to the third party servers 17 that influenced the purchase transaction.

FIG. 5 is a flowchart of one embodiment of a payment system receiving a payment request at a wireless terminal 18 and applying any discount for the item 30,32,34 that was looked up by the user 22. A payment request is received at the wireless terminal 18, and thus ultimately at the payment system whether it is at data center 16 or elsewhere, as shown at step 72. Then a determination is made as to whether the purchase is related to a specific good or service made with respect to a request from the paying device, as shown at determination 72. This request can be based on the specific account of the user 22 seeking to make payment, such as a mobile wallet on a mobile device 14, or a credit card payment account that is linked to the system 10, i.e., the discount determining system effecting the process of FIG. 4 utilizing an existing credit card payment system. If there is not a specific request for this device (or account) at decision 70, then, in this embodiment, the process forwards to determine if there are any discounts or other benefits for the items 30,32,34 desired to be purchased in the electronic payment transaction, which is a benefit to the user 22. The system 10 does not necessarily have to perform or effect this benefit.

If the purchase is related to a specific request at decision 72, then the information about the purchase is stored, possibly at data center 16 or locally, as shown at step 74. Thus, the system can store information about the user's 22 purchase, whether there are discounted items 32 in the purchase or not. Through this information, very important marketing data can be collected because the system will know what the user 22 was looking for, what they ultimately bought, and what they bought along with it. If questions are used to prompt the user, which can be embodied to occur at step 56 in FIG. 4, the data from that interaction can also be stored here at step 74. A determination is then made as to whether there are any discounted items in the purchase, as shown at decision 76. If there are not discounted items at decision 76, then the process terminates as shown at termination 80, as the electronic payment is simply effected. Otherwise, if there is a discount at decision 76, then the discount is applied to the purchase transaction as shown at step 78, and then the payment is made and the process terminates at termination 80. Step 78 can likewise be the application of other financial rewards to the user 22 for the present electronic transaction, or can be a credit or other economic benefit for a later transaction of the user 22.

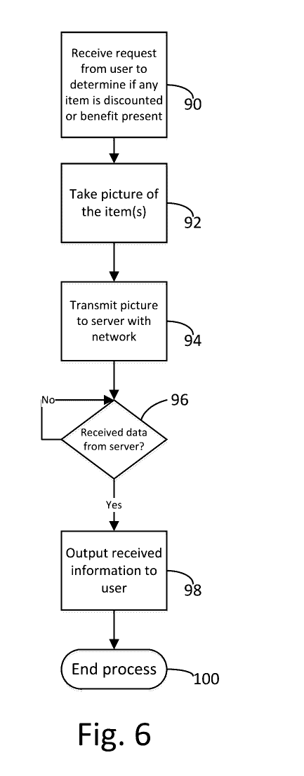

FIG. 6 is a flowchart of one embodiment of a process at a mobile device 14 to take a picture of one or more items 30,32,34 desired to be purchased, as shown in FIG. 2, transmit the information to the server, such as data center 16, and inform the user on received information regarding potential discounts or other applicable benefits. The request is received at the mobile device 14 from the user 22 to determine if a discount or other benefit is available for one or more items 30, 32, 34, as shown at step 90. This step can occur simply by opening the application resident on the mobile device 14 and taking a picture 26 of the items 30,32,34 as shown in step 92. The picture 26 is then transmitted to the data center 16 across the network 12 as shown at step 94, where the database can be reviewed for potential second transactional value units to the potential purchase transaction. A determination is then made as to whether there has been data received from the server, such as data center 16, as shown at decision 96.

If no data has been received from the database 15 at decision 96, the process enters a wait state for the data thereat. The wait state can terminate at a preset time so that the application does not hang. Otherwise, once data has been received at decision 96, then the received information is output to the user 22, as shown at step 98, and the process of the application terminates as shown at termination 100. The output information will indicate to the user 22 whether a second transactional value unit, e.g., a coupon, voucher, credit, bonus point, etc., is available for a potential purchase transaction.

Although preferred embodiments of the invention have been disclosed in the foregoing specification, it is understood by those skilled in the art that many modifications and other embodiments of the invention to which the invention pertains will come to mind, having the benefit of the teaching presented in the foregoing description and associated drawings. Moreover, although specific terms are employed herein, they are used in a generic and descriptive sense only, and not for the purposes of limiting the described invention.

What is claimed is:

1. A system for a providing a transactional advantage in a second transactional value unit to an electronic purchase transaction in a first transactional value unit, comprising:
at least one server that is selectively accessible to computer devices across a network;
a database, resident on the at least one server, that stores of potential purchase transactions and second transactional value units that are potentially applicable to potential purchase transactions, the second transactional value units having a different value than a first transactional value unit that can be used within a purchase transaction;
the server selectively receiving requests from requesting computer devices across the network regarding potential purchase transactions in a first transactional value unit;
the server further reviewing the database to determine the most optimal purchase transaction of the received request in view of the first transactional value units and second transactional value units applicable to the purchase transaction; and
the server sending information regarding, at least, the most optimal purchase transactional to the requesting computer device across the network for the purchase transaction.

2. The system of claim 1, further including at least a first computer device that receives requests from computer devices across a network regarding purchase transactions in a first transactional value unit, and the first computer device sending a request to the database for available second transactional value units to apply within the requested purchase transaction, the first computer device then sending the information on available transactional value units to the requesting computer device across the network.

3. The system of claim 1, wherein the received request is for a purchase transaction is for a plurality of potential purchase transactions and the server further determines the most optimal purchase transaction based upon the first transactional value units and second transactional value units available to each of the plurality of potential purchase transactions.

4. The system of claim 3, wherein the requesting computer device transmits data of a plurality of goods potentially to be purchased and the server further determines the most optimal purchase transactional for each of the plurality of goods based upon the first transactional value unit and second transaction value unit to the requesting computer device.

5. The system of claim 3, wherein the server is further configured to determine a second transactional value unit applicable to the potential purchase transaction that creates a most optimal purchase transaction within the plurality of potential purchase transactions.

6. The system of claim 1, wherein the server further determines a plurality of potential purchase transactions using first transactional value units and second transactional value units, including a most optimal potential purchase transaction, and relays the potential purchase transaction to the requesting computer device.

7. The system of claim 6, wherein the server further selectively receives information on whether any potential purchase transaction has been completed.

8. The system of claim 6, wherein the second transactional value units are only held within the database, and wherein server further selectively receives authorization of the purchase transaction and applies one or more first transactional value units to the purchase transaction.

9. The system of claim 8, wherein the server further sends first transactional value units to another computer system across the network that effects the purchase transaction.

10. The system of claim 1, wherein the server further effects the purchase transaction in the first transactional value unit.

11. The system of claim 1, wherein the server further sends the data of the potential purchase transaction to another computer device and selectively receives second transactional value units for the potential purchase transaction.

12. A system for a providing a transactional advantage in a second transactional value unit to an electronic purchase transaction in a first transactional value unit, comprising:
a computer means for storing and executing computer programs that is selectively communicates with computer devices across a network;
a database means for storing data of potential purchase transactions and second transactional value units that are potentially applicable to potential purchase transactions, the second transactional value units having a different value than a first transactional value unit that can be used within a purchase transaction, resident on the at least one server;
the computer means further for:
selectively receiving requests from requesting computer devices across the network regarding potential purchase transactions in a first transactional value unit;
reviewing the database means to determine the most optimal purchase transaction of the received request in view of the first transactional value units and second transactional value units applicable to the purchase transaction; and
sending information regarding, at least, the most optimal purchase transaction to the requesting computer device across the network for the purchase transaction.

13. The system of claim 12, further including at least a second computer means for:
receiving requests from computer devices across a network regarding purchase transactions in a first transactional value unit;
sending a request to the database means for available second transactional value units to apply within the requested purchase transaction; and
sending the information on available transactional value units to the requesting computer device across the network.

14. The system of claim 13, wherein the requesting computer device transmits data of a plurality of goods potentially to be purchased and the second computer means further for:
determining the most optimal purchase transaction for each of the plurality of goods based upon the first transactional value unit and second transactional value unit to the requesting computer device; and
determining a second transactional value unit applicable to the potential purchase transaction that creates a most optimal purchase transaction within the plurality of potential purchase transactions.

15. The system of claim 12, wherein the computer means further for effecting the purchase transaction in the first transactional value unit.

16. The system of claim 12, further including a data-capturing means for:
capturing data of at least one potential purchase transaction; and
transmitting the captured data to the computer means with a request for information on the most optimal purchase transaction.

17. The system of claim 12, wherein the computer means further for:
sending the data of the potential purchase transaction to another computer device; and
selectively receiving second transactional value units for the potential purchase transaction.

18. A method for a providing a transactional advantage in a second transactional value unit to an electronic purchase transaction in a first transactional value unit, comprising:
receiving requests at, at least, one server that is selectively accessible to computer devices across a network, the requests from requesting computer devices across the network regarding potential purchase transactions in a first transaction value unit;
reviewing a database, resident on the at least one server, to determine the most optimal purchase transaction of the received request in view of the first transactional value units and second transactional value units applicable to the purchase transaction, the database that storing data for potential purchase transactions and second transaction value units that are potentially applicable to potential purchase transactions, the second transactions value units having a different value than a first transactional value unit that can be used within a purchase transaction; and
sending information regarding, at least, the most optimal purchase transaction from the at least one server to the requesting computer device across the network for the purchase transaction.

19. The method of claim 18, wherein the received request for a purchase transaction is for a plurality of potential purchase transactions, and further includes determining the most optimal purchase transaction based upon the first transactional value units and second transactional value units available to each of the plurality of potential purchase transactions.

20. The method of claim 18, further comprising:
determining a plurality of potential purchase transactions using first transactional value units and second transaction value units, including a most optimal potential purchase transaction; and
relaying the potential purchase transaction to the requesting computer device.
